(19) United States
(12) Patent Application Publication
(10) Pub. No.: US 2014/0346031 A1
(43) Pub. Date: Nov. 27, 2014

(54) Pipe, device for carrying out mass transfer processes and use of the device

(71) Applicant: BASF SE, Ludwigshafen (DE)

(72) Inventors: Heinz-Josef Kneuper, Mannheim (DE); Jörg Torsten Nickel, Schonbrunn (DE); Luc Tirez, Stekene (BE)

(73) Assignee: BASF SE, Ludwigshafen (DE)

(21) Appl. No.: 14/361,325

(22) PCT Filed: Nov. 27, 2012
(86) PCT No.: PCT/EP2012/073707

§ 371 Date: May 29, 2014

Related U.S. Application Data
(60) Provisional application No. 61/566,013, filed on Dec. 2, 2011.

(30) Foreign Application Priority Data
Dec. 2, 2011 (EP) 11191665.6

(51) Int. Cl. B01D 5/00; B01D 53/00

(52) U.S. Cl. CPC B01D 5/00; B01D 53/002
USPC 202/158; 202/254

(57) ABSTRACT

The invention relates to a pipe (13) for conveying a condensable gas or a gas comprising condensable components, comprising at least one portion (15) inclined relative to horizontal. A ring (17) is accommodated in the portion (15) inclined relative to horizontal, which ring is joined to the pipe (13) by a first end face (21) in a liquid-tight manner over its entire circumference and whose diameter decreases towards a second end face (25) opposite the first end face (21), such that a space (27) is formed between the ring (17) and the internal wall of the pipe (13), the ring (17) is positioned in such a way in the pipe (13) that liquid condensing on the pipe wall flows into the space (27) between ring (17) and internal wall of the pipe (13), and an outlet (19), through which the liquid may flow out, opens into the space (27) through the wall of the pipe (13). The invention further relates to a device for carrying out mass transfer processes and to use of the device.

The invention relates to a pipe for conveying a condensable gas or a gas comprising condensable components, the pipe comprising at least one portion inclined relative to horizontal. The invention further relates to a device for carrying out mass transfer processes, comprising a column and a pipe for conveying a condensable gas or a gas comprising condensable components and to use of the device.

Pipes for conveying a condensable gas or a gas comprising condensable components are used for example as vapor lines on a column. To this end, the pipes are connected to the head of the column, such that the vapor may flow out of the column into the pipe. In many cases the pipes take the form of downcomers, which comprise a vertically extending portion, conventionally parallel to the column. Although the pipes are conventionally insulated, they are not heated, such that gas or condensable components of the gas may condense on the walls of the pipe. These form rivulets on the wall of the pipe and conventionally flow as far as a bend in the pipe, at which flow is diverted. When in particular a rising pipe portion or even a horizontal pipe portion adjoins the pipe bend, liquid collects in the pipe bend. This liquid then mixes again with the gas conveyed by the pipe. On the one hand, liquid in the form of aerosol droplets is entrained, while on the other hand some of the liquid is also evaporated again due to the hot gas conveyed by the pipe.

In particular in processes in which gases are conveyed by the pipe which are intended to be separated into condensable and noncondensable constituents, such mixing in pipe bends is undesirable, since in this way the separating action is impaired. Separation of the liquid in this case conventionally proceeds in liquid separators, into which the pipe leads.

Corresponding pipes are also used for example in the production of nitric acid as downcomers on an absorption column. In this case acid condenses in the pipe. This is undesirable however, since the condensing acid promotes corrosion on apparatus following the pipe, for example heat exchangers.

The object of the present invention is to provide a pipe and a device for carrying out mass transfer processes which allow condensable gases or gases comprising condensable components to be conveyed, with which the accumulation of liquid in pipe bends and optionally mixing of the liquid with the gas in pipe bends is prevented.

The object is achieved by a pipe for conveying a condensable gas or a gas comprising condensable components, which comprises at least one portion inclined relative to horizontal, wherein a ring is accommodated in the portion inclined relative to horizontal, which ring is joined to the pipe by a first end face in a liquid-tight manner over its entire circumference and whose diameter decreases towards a second end face opposite the first end face, such that a space is formed between the ring and the pipe, the ring is positioned in such away in the pipe that liquid condensing on the pipe wall flows into the space between ring and pipe, and an outlet, through which the liquid may flow out, leads into the space through the wall of the pipe.

As a result of the ring accommodated in a liquid-tight manner against the pipe wall, the liquid condensing on the pipe wall collects in the space between ring and pipe, such that said liquid cannot flow on into pipe bends. In this way, the amount of liquid collecting in pipe bends is minimized. This also reduces re-mixing of gas and liquid in the region of pipe bends. To prevent overflow of the space between ring and pipe, the space is provided with an outlet, through which the liquid accumulated in the space can flow out.

In a preferred embodiment, the ring is accommodated in the pipe at an angle to horizontal. This means that the end face with which the ring is fixed to the pipe is inclined relative to horizontal. Due to the inclination, the space between ring and pipe wall does not have a horizontal base. The liquid accumulated in this space flows towards the lowest point. The outlet from the space between ring and pipe is therefore preferably arranged at the lowest point of the space. This ensures complete discharge of the liquid from the space between ring and pipe. Complete discharge means, in this context, that substantially all the liquid may be discharged, but it cannot be ruled out that residual liquid may adhere to the pipe wall or ring and not arrive at the outlet. Such liquid would generally take the form of individual drops or a thin film.

The inclination at which the ring is accommodated in the pipe is preferably in the range of a 5 to 20% gradient, more preferably in the range of a 7 to 13% gradient and in particular in the range of a 9 to 12% gradient. A 100% gradient here means a 1 m drop over a horizontal distance of 1 m.

To achieve a ring diameter which decreases from the first end face to the second end face opposite the first end face, it is for example possible for the ring to assume a conical profile from the first end face towards the second end face. In this way, the space formed between pipe wall and ring has a substantially triangular cross section, the space not being upwardly delimited. In addition to a conical configuration, the ring may however for example also be parabolic, elliptical, hyperbolic or take the form of a segment of a circle. It is essential for the diameter to decrease from the first end face to the second end face and for there to be as far as possible no corners or edges in the ring, at which liquid may collect.

To achieve a liquid-tight connection of the first end face of the ring with the wall of the pipe, it is particularly preferable for the ring to be welded to the pipe over its entire circumference. It is however alternatively also possible to fix the ring in the pipe for example by a clamped joint or for example also by an adhesive joint, wherein in the case of an adhesive joint an adhesive must be used which is not damaged by the components comprised in the gas.

It is alternatively also feasible to fix the ring in place with a detachable connection, for example by screwing. In this case, it is on the one hand possible to fix the ring to the pipe wall with screws or alternatively to provide threads respectively in the pipe wall and on the ring and to screw the ring into the pipe wall. In the case of a detachable connection it is additionally advantageous to provide a sealing element with which the space formed between ring and pipe wall is sealed. To this and it is for example possible to insert sealing material into the thread, if the ring is screwed into the pipe wall. In this case a fibrous sealing material is particularly suitable, for example hemp fibers, as are known from the installation of pipes. Alternatively, however, any other sealing material is also feasible. The only essential feature in this context is that the sealing material layer is inert relative to the condensable gas or the components of the gas and is not damaged by the gas or individual components comprised in the gas.

Bonded connection of the ring to the pipe is particularly preferred, however, such that sealing is achieved at the same time as connection.

In a particularly preferred embodiment, the portion of the pipe inclined relative to horizontal is substantially vertical. Substantially vertical means that the angle of the pipe to horizontal is in the range from 85 to 95 degrees, preferably in the range from 89 to 91 degrees.

Depending on the length of the pipe, one or more rings may be provided. If a plurality of rings are provided, these are uniformly distributed over the length of the pipe. Irrespective of whether one or more rings are provided, it is preferable for one ring to be located at the end of the pipe portion inclined relative to horizontal. The end is in this case the portion of the pipe portion flowed through last in the flow direction. In particular if a pipe bend follows, it is advantageous to arrange the ring directly before the pipe bend.

In one embodiment of the invention, the pipe is for example a downcomer for discharging vapor from a column. Vapor is understood in this connection to be condensable gaseous components which are discharged at the head of a column. The pipe may in this case lead in both from above at the column top and as a lateral outlet in the head region of the column.

Particularly preferably, the pipe according to the invention is used to convey vapor. In this case, the pipe preferably leads into a condenser, in which the gaseous vapor is condensed. If, in addition to condensable constituents, the vapor comprises components which are not condensable under the conditions prevailing in the condenser, only the condensable components are condensed in the condenser. The gas liquid mixture which arises through condensing of the condensable constituents is then fed to a liquid separator. In the liquid separator the gaseous constituents are then separated from the liquid constituents.

If in particular the vapor comprises constituents which have a corrosive action, corresponding constituents should be prevented from condensing on the walls of the pipe and remaining there for an extended period, as may for example occur in pipe bends. Due to the long contact time between the condensed liquid and the surface of the pipe, corrosion arises which may lead to damage to the pipe and optionally to failure of the pipe.

If the vapor passed through the pipe is fed to a liquid separator after condensing of the condensable constituents, it is particularly preferable for the outlet from the space between ring and pipe likewise to lead into the liquid separator.

The pipe through which the condensable gas or the gas comprising condensable components is fed to the liquid separator preferably leads into the gas space of the liquid separator. In this respect it is possible for the liquid separator to act simultaneously as a condenser and to comprise a temperature at which condensable parts condense out of the gas. It is alternatively also possible to arrange the liquid separator upstream of a condenser.

It is furthermore preferable for the outlet from the space between the ring and the pipe to open as an immersion tube in the liquid in the liquid separator. By arranging the outlet to open in the liquid separator, the liquid already condensed in the pipe is fed to the liquid separated in the liquid separator. This limits liquid losses. The arrangement of the outlet such that it opens as an immersion tube in the liquid in the liquid separator has the advantage that gas-tight discharge out of the space between ring and pipe is achieved. In the case in particular of a small amount of liquid being discharged through the outlet from the space between ring and pipe, this prevents gas from the liquid separator from flowing back into the pipe through the pipe forming the outlet.

In a particularly preferred embodiment, the pipe is part of a device for carrying out mass transfer processes. Such a device for carrying out mass transfer processes generally comprises a column and the pipe as downcomer. The pipe opens in this case at the head of the column, such that a gaseous overhead product may be drawn off from the column through the pipe.

The column is in this case a conventional mass transfer column, for example an absorption column or a gas scrubber. It is moreover also possible for the column to be a distillation column.

Such a mass transfer column, used for the mass transfer process, conventionally comprises internals, for example in the form of structured packing, unstructured packing, for example in the form of packing pieces, or trays.

Conventionally, such a column is operated in two phases. At the head a gaseous product is drawn off and at the bottom of the column a liquid product.

The device comprising the pipe according to the invention for carrying out mass transfer processes is particularly suitable for use in a method for producing nitric acid.

To produce nitric acid, firstly ammonia is oxidized with oxygen to yield nitrogen monoxide and water. The nitrogen monoxide further oxidizes with oxygen to yield nitrogen dioxide. The nitrogen dioxide is supplied as a component to an absorption column. In this case, the nitrogen dioxide is conventionally supplied in the region of the column bottom. Water is fed in at the head of the column. The nitrogen dioxide and the water run countercurrently through the column, intensive mixing of nitrogen dioxide and water being achieved by suitable internals. As a result of the intensive mixing, nitrogen dioxide is absorbed in the water and forms nitric acid and nitrogen monoxide. The nitric acid is drawn off at the bottom of the column. At the head of the column a mixture arises which comprises gaseous nitrogen monoxide and gaseous nitric acid. This is drawn off at the head of the column via the pipe according to the invention. In the pipe, nitrogen dioxide reacts with water contained in the gas stream to yield nitric acid, which condenses on the pipe walls. Condensing of the nitric acid in the pipe is undesirable, since the nitric acid is highly corrosive. In particular, the accumulation of nitric acid for example in pipe bends leads to corrosion of the pipe.

By means of the pipe formed according to the invention, with the ring accommodated therein, nitric acid condensing on the walls of the pipe is caught and removed from the pipe. This prevents nitric acid which has already condensed in the region of pipe bends from being remixed with the gas conveyed by the pipe and additionally prevents large amounts of liquid from accumulating in regions of the pipe, particularly in the pipe bends. The nitric acid collecting in the space between ring and pipe is discharged via the outlet and fed to a liquid separator, in which the nitric acid drawn off in gaseous form from the column is condensed.

During absorption, water is evaporated due to the heat of absorption released, such that at the head of the column a material stream is discharged which contains vaporous water, nitrogen, oxygen, and nitrogen monoxide and nitrogen dioxide not absorbed inside the column. Because of the water content in the pipe, the nitrogen dioxide reacts further with the water to yield nitric acid.

The material from which ring and pipe are made depends on the condensable gas or gas comprising condensable components conveyed in the pipe. The material is preferably selected such that it is not damaged by the gas or individual components of the gas. If the pipe according to the invention is used in a method for producing nitric acid, a particularly suitable material is a steel. A particularly suitable material is steel with the material number 1.4541.

The outlet from the space between ring and pipe may have a constant diameter or a varying diameter. If the diameter varies, it is in particular possible first of all to provide a pipe portion with a larger diameter, which is reduced by means of a reducing fitting to a smaller diameter. In order to draw off the liquid from the space between ring and pipe, it is furthermore preferable for the outlet not to rise at all, i.e. for it to be joined to the pipe horizontally or with a downwardly directed inclination. This allows gravity-controlled discharge of the condensed liquid out of the space between ring and pipe.

Exemplary embodiments of the invention are illustrated in the figures and explained in more detail in the following description.

In the drawings:

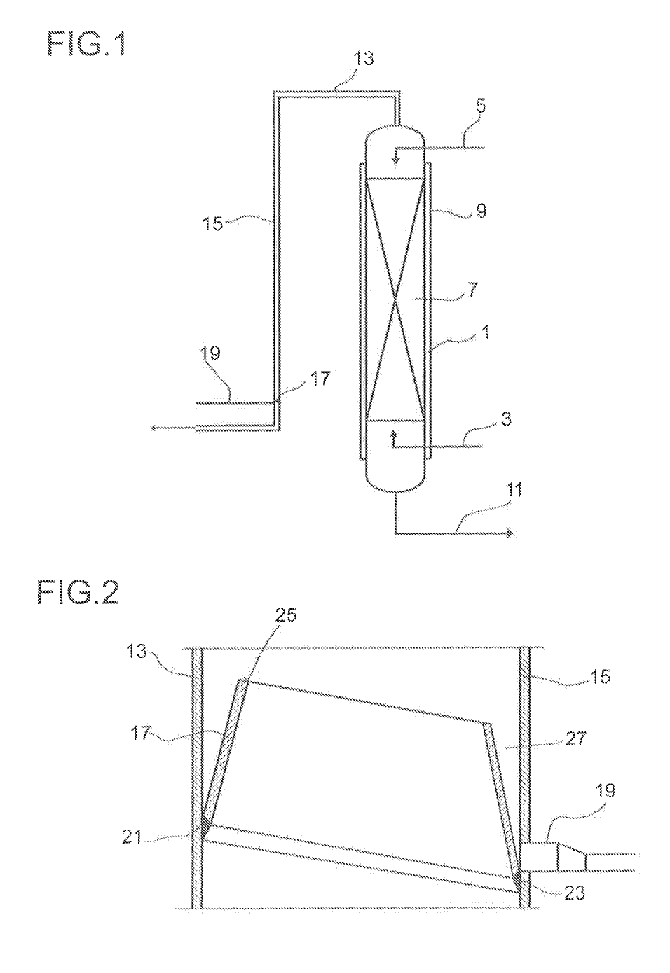

FIG. 1 is a schematic representation of a mass transfer column with a pipe formed according to the invention,

FIG. 2 is a sectional drawing of a pipe portion with ring accommodated therein.

FIG. 1 is a schematic representation of a mass transfer column with a pipe according to the invention.

A mass transfer column 1 comprises for example a feed 3 for a first starting material. The first starting material may for example be supplied as shown in FIG. 1 in the lower region of the column, for example at the bottom of the column. If the mass transfer column 1 is an absorption column or a gas scrubber, the first product, which is supplied via the feed 3, is gaseous. In this case, the first starting material may be introduced via the feed 3 through any desired gas distributor into the mass transfer column 1.

A second starting material is supplied via a second feed 5 at the head of the column. The second starting material is liquid in the case of a mass transfer column 1 in the form of an absorption column or gas scrubber. The gaseous first starting material and the liquid second starting material are supplied countercurrently in the mass transfer column 1. In this case, suitable internals enable the achievement of intensive mixing of gaseous first starting material and liquid second starting material. In an absorption column, at least part of the gaseous first starting material is absorbed in the liquid second starting material. In this case, a chemical reaction may occur, in which components of the gaseous first starting material react chemically with components of the liquid second starting material.

If the mass transfer column 1 is a gas scrubber, constituents of the gaseous first starting material are taken up by the liquid second starting material. In this case, a chemical reaction may likewise occur, but it is also possible for the constituents taken up by the liquid merely to dissolve in the liquid.

To achieve intensive mixing of the liquid supplied via the second feed 5 and of the gas supplied via the first feed 3, internals 7 are contained in the mass transfer column 1. The internals may for example take the form of structured packing, random dumped packing, for example in the form of packing pieces, or of trays. If the internals 7 are trays, they conventionally comprise an inlet weir and an outlet weir for the liquid and gas passage openings through which the gas may flow. The trays here generally take the form of cross-flow trays, with the liquid flowing over the tray from the inlet to the outlet and the gas being passed through the liquid via the gas passage openings. The gas passage openings may here take the form of sieve holes, valves, bubble caps or tunnel caps.

If a process is carried out in the mass transfer column 1 in which heat is released or heat is needed, it is possible to provide the mass transfer column 1 with a temperature control unit 9. The temperature control unit 9 may here for example take the form of a double jacket, which surrounds the column. In this case, a suitable temperature control medium flows through the double jacket. It is alternatively also possible for example to provide an appropriate temperature control unit inside the mass transfer column 1, for example in the form of heated or packed pipes or the like. If the internals 7 take the form of trays, it is possible, for example, to arrange pipes on the trays through which a temperature control medium flows.

To draw the liquid off from the column, a liquid outlet 11 is located at the bottom of the column. At the head of the column gaseous constituents, known in general also as vapor, are drawn off via a pipe 13. The pipe 13 may in this case, as shown in FIG. 1, be fitted to the top of the column. It is alternatively also possible to fit the pipe 13 to the side of the mass transfer column head.

According to the invention, the pipe 13 takes the form of a downcomer, i.e. the pipe 13 comprises a substantially vertically extending portion 15.

Conventionally, the pipe 13 and thus also the vertically extending portion 15 is not heated or cooled, such that some of the gas conveyed in the pipe 13 or some of the constituents of the gas may condense on the wall of the pipe 13.

The condensing constituents may collect in pipe bends. This may lead, in particular if the constituents are corrosively acting constituents, to corrosive damage to the tube.

According to the invention, the pipe 13 therefore comprises a ring 17 in the vertically extending portion 15, preferably at the end of the vertically extending portion 15. The ring 17 is configured such that a space forms between the pipe 13 and the ring 17, in which space the liquid condensed on the walls accumulates. The liquid is drawn off from the space formed between ring 17 and pipe 13 via an outlet 19.

If the mass transfer column 1 is an absorption column, which is used to produce nitric acid, gaseous nitrogen monoxide and nitrogen dioxide are supplied via the first feed 3 as first starting material. The proportion of nitrogen dioxide is in this case greater than 95 vol %. In addition, the gaseous first starting material may still contain traces of nitrogen and oxygen.

Water is added via the second feed 5.

In the column, nitrogen dioxide is absorbed in the water and there forms nitric acid and nitrogen monoxide. The nitrogen monoxide reacts with oxygen to yield nitrogen dioxide and further forms nitric acid, nitrogen monoxide furthermore arising.

At the bottom of the mass transfer column 1, nitric acid is drawn off via the liquid outlet 11. At the head of the mass transfer column 1, a mixture of water, nitrogen, oxygen and traces of nitrogen monoxide and nitrogen dioxide arise. The nitrogen dioxide reacts with the water to yield nitric acid. This condenses in the pipe 13. According to the invention, the condensing nitric acid is caught in the space between ring 17 and pipe 13 and drawn off from the pipe via the outlet 19. This prevents a liquid film of nitric acid adhering to the pipe and leading to corrosion. In addition, liquid nitric acid is prevented from being introduced into downstream apparatus, which may likewise result in corrosive damage to the apparatus.

The pipe portion with the ring accommodated therein, for collecting condensing liquid, is shown in FIG. 2.

The ring 17 comprises a first end face 21, with which the ring 17 is fixed to the wall of the pipe 13. The ring 17 is in this case fixed by a weld seam 23 to the vertically extending portion 15 of the pipe 13. The joint formed by the weld seam 23 produces a liquid-tight joint. From the first end face 21, with which the ring 17 is fixed to the pipe 13, the diameter decreases towards a second end face 25. In the embodiment illustrated herein, the ring 17 is in this case of conical construction. As a result of the conical configuration of the ring 17, a space 27 forms between the ring 17 and the wall of the pipe 13. In addition to the conical configuration shown here, the ring 17 may also exhibit any other desired configuration in which the diameter of the first end face 21 is greater than the diameter of the second end face 25, wherein the diameter of the first end face 21 must always be selected such that a liquid-tight joint with the pipe may be produced.

In addition to a welded joint provided by the weld seam 23, the ring 17 may also be screwed or adhesively bonded to the pipe 13 or fixed in the pipe 13 in some other way. In the case of a noninterlocking joint, for example a screwed joint, however, additional sealing is necessary, to ensure that no liquid can flow out of the space 27 along the internal wall of the pipe 13. In the case of an adhesive joint, an adhesive should be used which is not damaged by substances which are conveyed in the pipe. Any seal must also be made of a sealing material which is inert relative to the components conveyed in the pipe.

In a preferred embodiment, the ring 17 is inclined relative to horizontal, as shown in FIG. 2. The inclination here preferably comprises a gradient in the range from 5 to 20%, in particular in the range from 7 to 15%, particularly preferably in the range from 9 to 12%.

As a result of the inclination, the liquid collecting in the space 27 between ring 17 and pipe 13 passes to the lowest point. The outlet 19 is located at the lowest point. Via the outlet 19 the liquid is then discharged from the space 27.

In a preferred embodiment, the gas conveyed in the pipe 13 passes into a liquid separator. In the liquid separator, condensable constituents are condensed out of the gas and collected. This results in separation into a gaseous and a liquid phase. So as not to lose any valuable substances, the liquid already condensed in the pipe, which is discharged via the outlet 19, is also particularly preferably introduced into the liquid separator. To ensure that no gas can flow out of the liquid separator through the outlet 19 into the pipe, it is additionally preferable for the outlet 19 to open in the liquid in the liquid separator in the form of an immersion tube. Immersion of the immersion tube in the liquid results in a gas-tight seal, such that no gas can pass from the liquid separator into the outlet 19.

### List of Reference Numerals

1 Mass transfer column
3 Feed for first starting material
5 Second feed
7 Internals
9 Temperature control unit
11 Liquid outlet
13 Pipe
15 Vertically extending portion
17 Ring
19 Outlet
21 First end face
23 Weld seam
25 Second end face
27 Space

1-8. (canceled)

9. A pipe for conveying a condensable gas or a gas comprising condensable components, comprising at least one portion inclined relative to horizontal, wherein a ring is accommodated in the portion inclined relative to horizontal, which ring is joined to the pipe by a first end face in a liquid-tight manner over its entire circumference and whose diameter decreases towards a second end face opposite the first end face, such that a space is formed between the ring and the internal wall of the pipe, the ring is positioned in such a way in the pipe that liquid condensing on the pipe wall flows into the space between ring and internal wall of the pipe, an outlet, through which the liquid may flow out, leads into the space through the wall of the pipe and the pipe is a downcomer for discharging vapor from a column.

10. The pipe according to claim 9, wherein the ring is accommodated in the pipe at an angle to horizontal.

11. The pipe according to claim 9, wherein the ring has a conical profile from the first end face to the second end face.

12. The pipe according to claim 9, wherein the pipe leads into a gas space of a liquid separator.

13. The pipe according to claim 12, wherein the outlet out of the space between ring and internal wall of the pipe opens as an immersion tube in the liquid in the liquid separator.

14. A device for carrying out mass transfer processes, comprising a column and a pipe according to claim 9 as a downcomer, the pipe opening at the head of the column, such that a gaseous overhead product may be drawn off from the column through the pipe.

15. The device according to claim 14, wherein the column is an absorption column or a gas scrubber.

16. The device according to claim 14 for producing nitric acid.
